(19) United States
(12) Patent Application Publication
(10) Pub. No.: US 2004/0031360 A1
(43) Pub. Date: Feb. 19, 2004

(54) Hex wrench

(76) Inventor: Chien-Cheng Her, Kaohsiung Hsien (TW)

Correspondence Address: Charles E. Baxley, Esquire, 5th Floor, 59 John Street, New York, NY, 10038, US

(21) Appl. No.: 10/218,066

(22) Filed: Aug. 14, 2002

(51) Int. Cl. B25B 15/00

(52) U.S. Cl. 81/436

(57) ABSTRACT

A hex wrench includes a head with notches defined in an outer periphery thereof and the notches are located to face the inside of the object. The inside of the object is deformed during being rotated by the head and engaged with the notches so as to increase the feature of anti-slippery between the head of the wrench and the object.

### FIELD OF THE INVENTION

The present invention relates to a hex wrench having grooves defined in an outer periphery of the head of the wrench so as to increase the friction between the insides of the object and the head of the wrench.

### BACKGROUND OF THE INVENTION

A conventional hex wrench is shown in FIG. 1 and generally includes a head 11 and a handle 10 wherein the head 11 is inserted in a recess 13 of an object to be tightened or loosened. The recess 13 includes six surfaces which are matched with the six surfaces of the head 11 so that when rotating the handle 10, the object 12 is rotated. The material of the hex wrench is harder than that of the object 12 so that it is often to damage the corners between the six surfaces of the object 12 as shown in FIG. 2 and the rounded corners make the engagement between the head 11 of the hex wrench and the object 12 to be unstable and the head 11 could slip from the corners. Besides, the inside end of the object 12 is not perpendicular to the six surfaces of the recess 13, however, the bottom of the head 11 is perpendicular to the six surfaces of the head 11 so that the head 11 cannot be securely matched with the recess 13, and this causes slippery rotation.

The present invention intends to provide a hex wrench that has notches in an outer periphery of the head so as to securely match with the recess of the object.

### SUMMARY OF THE INVENTION

In accordance with one aspect of the present invention, there is provided a hex wrench which comprises a head and a handle, the head having notches defined in an outer periphery thereof. The deformed insides of the object are engaged with the notches of the wrench so as to increase the engagement therebetween.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional hex wrench and an object with a recess;

FIG. 2 shows the corners of the recess of the object are rounded by the head of the conventional hex wrench made of harder material;

FIG. 3 is a perspective view to show the hex wrench of the present invention;

FIG. 4 is a cross sectional view to show that the head of the hex wrench of the present invention is engaged with the recess of an object;

FIG. 5 is an enlarged cross sectional view to show the engagement of the head of the hex wrench and the inside of the object;

FIG. 6 is a bottom view to show the rounded edge of the head of the hex wrench of the present invention, and

FIG. 7 shows knurled surfaces are defined in the outer periphery of the head of the hex wrench of the present invention.

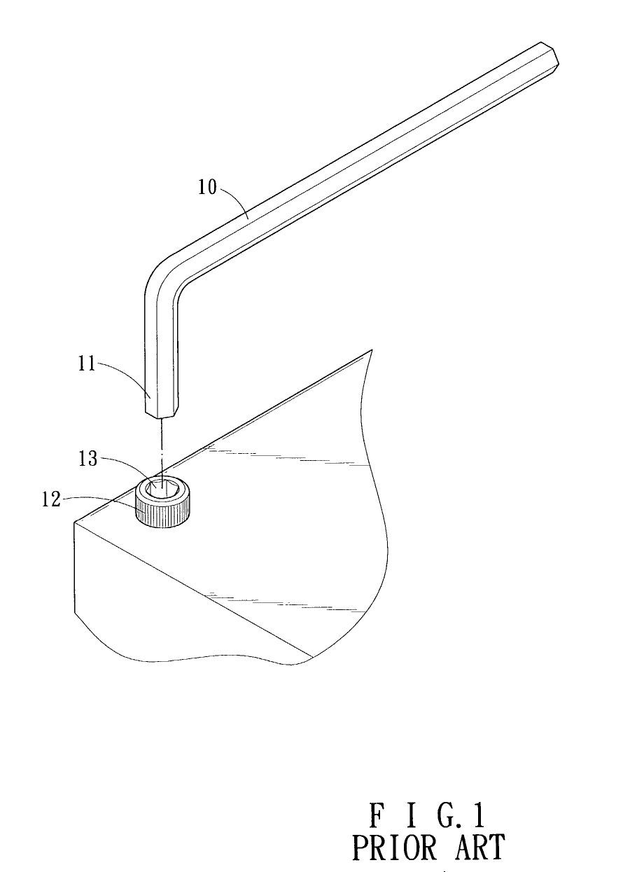

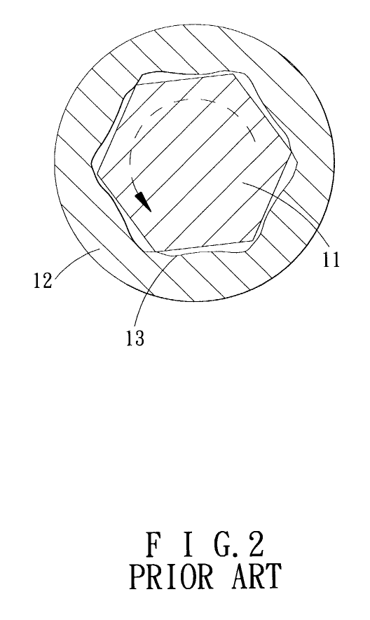

### DETAILED DESCRIPTION OF THE PREFERRED EMBODIMENT

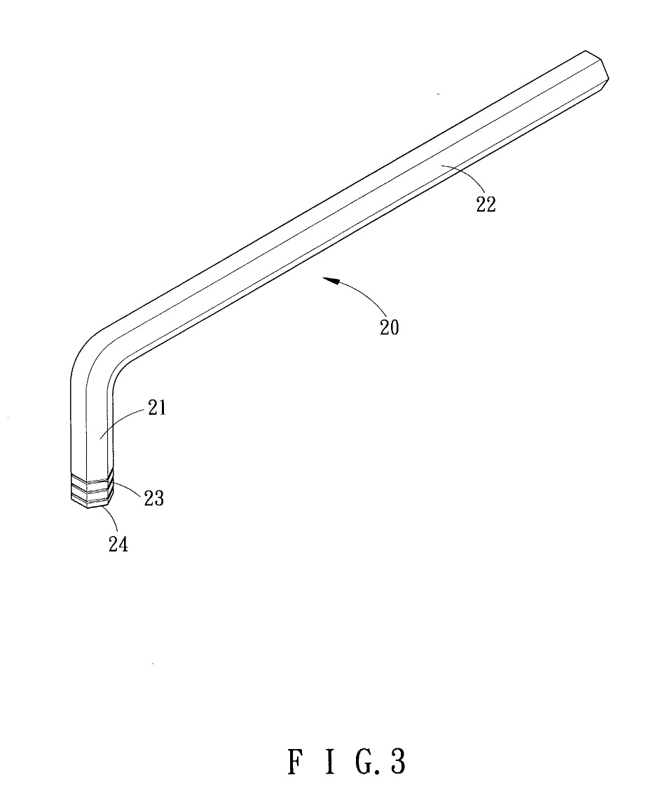

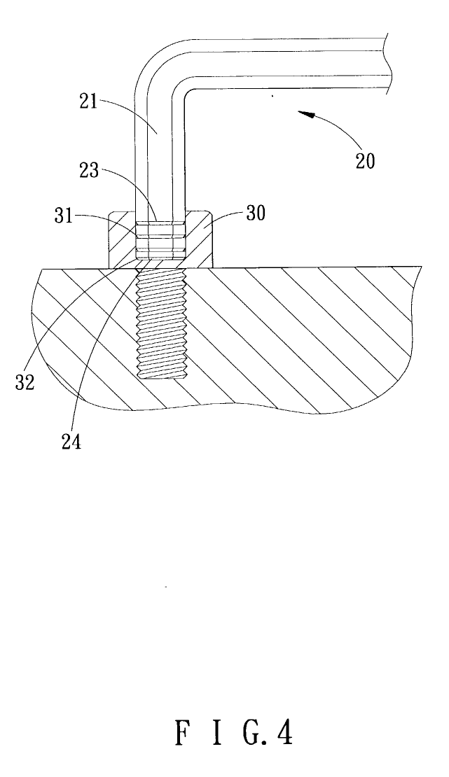

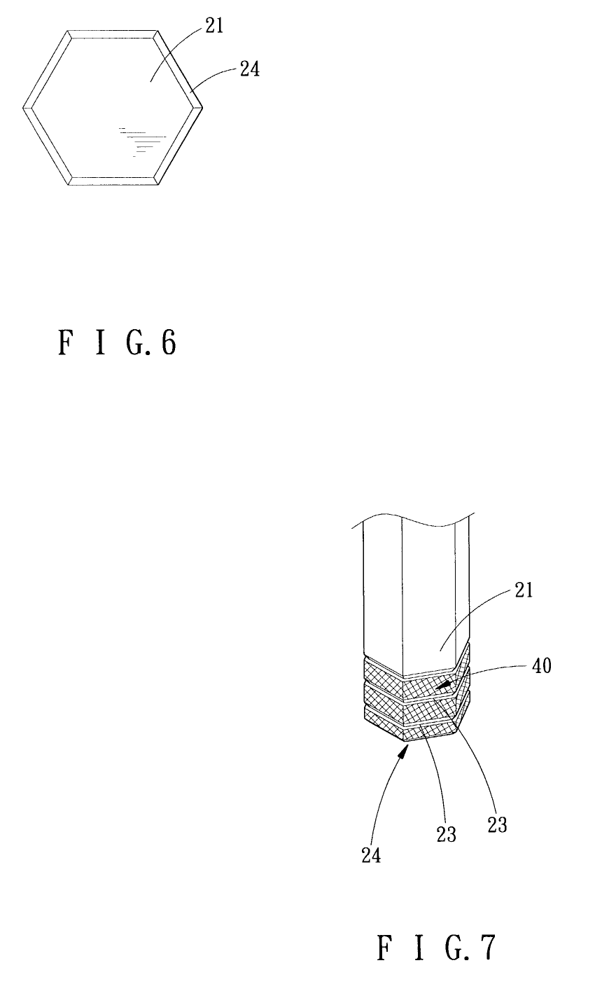

Referring to FIGS. 3 to 5, the hex wrench 20 of the present invention comprises a head 21 and a handle 22 which is perpendicular to the head 21. The head 21 has notches 23 defined in an outer periphery thereof and the notches 23 are located to face the insides 31 of the object 30. Further referring to FIG. 6, a distal end of the head 21 includes a rounded edge 24 which is able to match with an end surface of the recess of the object 30.

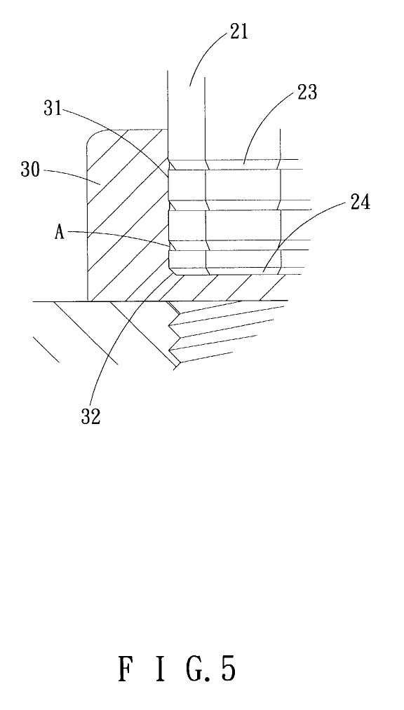

When rotating the handle 22, the insides 31 of the recess of the object 30 are slightly deformed and engaged with the notches 23 as shown in “A” in FIG. 5, this increases the engagement between the head 21 and the recess of the object 30 such that the object can be rotated by the head 11 correctly. The rounded edge 24 is matched with the end of the recess of the object 30 so that the head 11 does not slip in the recess.

FIG. 7 shows that knurled surfaces 40 are defined in the outer periphery of the head 21 and the knurled surfaces 40 increase the friction between the head 11 and the insides of the recess of the object 30.

While we have shown and described the embodiment in accordance with the present invention, it should be clear to those skilled in the art that further embodiments may be made without departing from the scope of the present invention.

What is claimed is:

1. A hex wrench comprising:
a head and a handle, the head having notches defined in an outer periphery thereof.

2. The wrench as claimed in claim 1, wherein a distal end of the head includes a rounded edge which is adapted to match with an end surface of a recess of an object.

3. The wrench as claimed in claim 1 further comprising knurled surfaces defined in the outer periphery of the head.
